(19) United States
(12) Patent Application Publication
(10) Pub. No.: US 2012/0088102 A1
(43) Pub. Date: Apr. 12, 2012

(54) NONHALOGENATED FLAME RETARDANT ADHESIVES AND TAPES

(75) Inventors: Wei-Cheng Su, Taoyuan City (TW); Rafael Garcia-Ramirez, Austin, TX (US); Eumi Pyun, Austin, TX (US); Haohao Lin, Austin, TX (US)

(73) Assignee: 3M Innovative Properties Company

(21) Appl. No.: 12/899,417

(22) Filed: Oct. 6, 2010

(51) Int. Cl. B32B 15/082; C09J 133/08

(52) U.S. Cl. 428/355 AC; 524/101

(57) ABSTRACT

Flame retardant adhesives and tape articles include a nonhalogenated flame retardant composition comprising a combination of melamine phosphate and melamine cyanurate.

### FIELD

This disclosure relates to adhesives and adhesive articles that include a nonhalogenated flame retardant composition.

### BACKGROUND

Flame retardant adhesives and tapes are used in many industries and for many different purposes. They are used, for example, in the electrical industry as insulating tapes. Flame retardant compositions, widely used as flame retardant adhesives and tapes, utilize one or more halogen-containing materials. However, environmental and safety concerns regarding use of halogen-containing materials in adhesives and related articles have been raised and in response to these concerns, many nonhalogenated flame retardant materials have been introduced to be used in place of halogen-containing materials. In some instances, when larger amounts of nonhalogenated flame retardant materials are used, there can be undesirable effects, such as reduction in tackiness of the adhesive. U.S. Pat. No. 6,022,914 (Nowack et al.) overcomes this problem by overcoating such an adhesive composition with a thin layer of an adhesive not containing any of the nonhalogenated flame retardant composition or a low level of nonhalogenated flame retardant composition which does not inhibit the tackiness of the adhesive.

### SUMMARY

Thus, it is desirable to have nonhalogenated, flame retardant compositions that offer flame resistant properties and also that maintain functional adhesive performance. There is also a desire for articles that contain such compositions.

With the present invention, it was unexpectedly found that although melamine phosphate and melamine cyanurate flame retardants individually achieved only a CTI rating of IIIa, when the two were combined, they achieved a CTI rating of I.

In one aspect, flame retardant adhesives are provided that are useful, for example, in the construction of tapes. The flame retardant adhesives include a flame retardant composition that includes a melamine phosphate and a melamine cyanurate.

In another aspect, a tape construction is provided that includes a support material that is substantially free of halogenated materials, has at least two major surfaces, an adhesive disposed on at least one major surface of the support material and a flame retardant composition that includes a melamine phosphate and a melamine cyanurate. The flame retardant composition can be present in or incorporated into either or both of the adhesive and the support material. The flame retardant composition may also be present as or incorporated into an independent structural or functional layer within the tape construction.

Thus, adhesives and tapes are provided that offer desired flame retardant properties, are simple to make and use, and provide acceptable performance as an adhesive or a tape.

The above summary is not intended to describe each disclosed embodiment of every implementation of the present disclosure. The detailed description which follows more particularly exemplifies illustrative embodiments.

### DETAILED DESCRIPTION

It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

In this disclosure,

“halogen-free” and “nonhalogenated” are used inter-changeably herein and refer to the substantial absence, e.g., trace or ineffective amounts, of halogens, i.e., fluorine, chlorine, bromine, iodine, and astatine;

“flame retardant compositions” refers to halogen-free or nonhalogenated flame retardant or flame resistant compositions;

“flame retardant materials” refer to one or more nonhalogenated flame retardant materials that make up the flame retardant compositions presented herein;

“flame retardant adhesives or tapes” refer to adhesives and tapes incorporating flame retardant compositions presented herein that can pass the requirements set forth by the flame test of industry standard UL 510 (Underwriters Laboratories Inc., Eighth Edition);

“melamine phosphate(s)” refers to melamine monophosphate(s), melamine polyphosphate(s), and melamine pyrophosphate(s); and

“halogen-free flame retardant” and “nonhalogenated flame retardant” refer to flame retardant compositions that do not contain halogens.

Acceptable adhesive performance refers to meeting the requirements as set forth by the adhesion test included in ASTM D1000-04 (Standard Test Methods for Pressure-Sensitive Adhesive-Coated Tapes Used for Electrical and Electronic Applications). Acceptable insulation performance refers to meeting the requirements as set forth by UL 510 in regards to dielectric strength, before and after humidity exposure, and insulation resistance. Said tests are based on ASTM D-149-97a (Standard Test Method for Dielectric Breakdown Voltage and Dielectric Strength of Solid Electrical Insulating Materials at Commercial Power Frequencies, 2004), which provides standard procedures for the determination of dielectric strength of solid insulating materials at commercial power frequencies, under specified conditions. In addition, insulation performance refers to the evaluation of the Comparative Tracking Index (“CTI”) or the ASTM D-149-97a test. The CTI test is used to measure material degradation properties under electrical stress (tracking) of an insulating material as set forth in ASTM D3638-07 (Standard Test Method for Comparative Tracking Index of Electrical Insulating Materials, 2007).

Adhesives and tape constructions are provided that are flame retardant. An adhesive or a tape can be considered flame retardant when it can inhibit or resist spread of fire. According to the flame test described in UL510 standard, in order for an adhesive or a tape test specimen to be considered flame retardant, when a test flame is applied to the test specimen, it can not flame longer than 60 seconds following any of five 15 seconds applications of the test flame, the period between applications being: a) 15 seconds if the specimen flaming ceases within 15 seconds; or b) the duration of the specimen flaming if the specimen flaming persists longer than 15 seconds. The test specimen should not ignite combustible materials in its vicinity or damage more than 25 percent of the indicator flag during, between, or after the five applications of the test flame.

The flame retardancy of the disclosed adhesives and tapes is provided by the included flame retardant compositions. The disclosed flame retardant compositions are nonhalogenated and include a combination of two particular flame retardant materials: melamine phosphate and melamine cyanurate. Optionally, the flame retardant compositions may also include one or more additional nonhalogenated flame retardant materials such as alumina trihydrate (Al₂O₃.3H₂O) and magnesium hydroxide (Mg(OH)₂). Commercially available examples of include, but are not limited to those available under the trade designations HYMOD (Huber Corp., Edison, N.J.) or POLYFILL (R. E. Carroll, Inc., Trenton, N.J.). However, these materials should not be added in amounts that would lower the CTI rating of the flame retardant composition. These compositions may be part of the adhesive or incorporated into the tape construction or disposed on the backing as a separate layer or a combination thereof.

The melamine phosphate portion of the flame retardant composition is represented by:

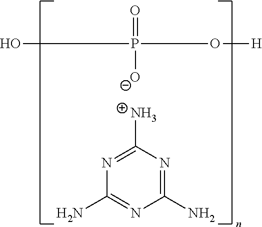

Wherein

when n=1 it's melamine (mono)phosphate,

when n=2 it's melamine pyrophosphate, and

when n=3 it's melamine polyphosphate

Commercially available examples of suitable melamine phosphates include, but are not limited to those available under the trade designations MPP-B, a melamine pyrophosphate, available from Kuo Fong Enterprises, Taiwan, MELAPUR 200, a melamine polyphosphate, available from Ciba (now part of BASF), Germany; and BUDIT 3141, a melamine polyphosphate, available from Budenheim, Spain.

The melamine cyanurate portion of nonhalogenated flame retardant composition is represented by:

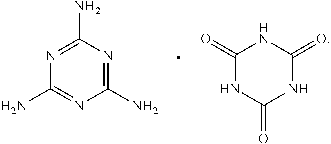

Commercially available examples of suitable melamine cyanurates include, but are not limited to those available under the trade designations MELAPUR MC 15, available from Ciba (now part of BASF), Germany; CG-610, available from Chemgarde, Taiwan.

The weight ratio of melamine phosphate to melamine cyanurate may be from about 1:6 to about 2:1.

The total amount of flame retardant compositions as well as the amounts of each of the flame retardant materials that make up the total amount of flame retardant composition used may be varied over a wide range but are present in an amount sufficient to render the adhesive or tape flame retardant. As the total amount of flame retardant and/or the relative amounts of flame retardant materials that make up the flame retardant are changed, the performance properties such as adhesion may be adversely affected depending on the intended application for the adhesive or tape. Within these parameters, a preferred lower limit for the flame retardant in the flame retardant adhesive or backing can be about 30% by weight (30 wt %), and in some cases about 35 wt % and yet in other cases about 38 wt %. A preferred upper limit can be about 60 wt %, and in some cases about 50% wt % and yet in other cases about 40 wt %.

In some embodiments, the disclosed flame retardant composition offers desired flame retardant properties without substantially affecting functional performance of the adhesives and tapes, such as failure of adhesion to an intended surface or reduction in insulating properties of an insulating tape. Exemplary adhesive and tape constructions with flame retardant compositions containing appropriate amounts of the combination of melamine phosphate and melamine cyanurate, together with or without one or more additional flame retardant materials incorporated, show advantageous properties and characteristics in comparison to their properties individually. Specifically, as shown in Table 2, when either of the melamine phosphate or melamine cyanurate flame retardant materials of the composition are present individually in adhesives or tape constructions they only achieve a CTI rating of IIIa. Surprisingly, synergistic results are obtained when the provided flame retardant compositions are used at appropriate levels in the adhesives or tape constructions whereby CTI ratings of I are achieved. For example, as shown in Table 3, adhesives and tape constructions with the appropriate flame retardant combination of the present invention can pass the industry standard UL 510 flame retardancy test and can achieve a Comparative Tracking Index (“CTI”) rating of I.

In various embodiments of the invention, the flame retardant compositions can be included within an adhesive material in order to impart desired flame retardant properties to the adhesives. Useful adhesives include many different types and forms, such as pressure sensitive adhesives, thermoset adhesives, hot-melt adhesives, and other types of adhesives. As is well known in the art, when described by their relative chemical compositions, adhesives may be grouped as acrylic adhesives, polyolefin adhesives, styrenic co-polymer adhesives, silicone adhesives, epoxy adhesives, ethylene co-polymer adhesives, and other types of adhesives. The provided nonhalogenated flame retardant compositions may be incorporated into any of these adhesive materials to impart desired flame retardant properties to the adhesives.

The provided flame retardant compositions may also be used in adhesives or tape constructions together with other materials. Many adhesives, for example, include one or more cross-linking compositions such as, for example, a bis-amide. Adhesives or tape constructions also often incorporate one or more tackifier compounds to manage a desired tack characteristic of the adhesive or tape. Inclusion of other customary additives, adjuvants, agents and materials (e.g., colorants, pigments, primers, fillers, UV absorbers, and conductive particles) are understood by those skilled in the art.

Adhesives incorporating the provided flame retardant compositions may be used in any application for which the underlying adhesive without the flame retardant composition is intended and for which a degree of flame retardancy is desired. The provided flame retardant compositions also find particular utility in tape constructions. Such tape constructions generally comprise a support material onto which one or more functional or structural layers are applied (typically by coating). One or more of the provided flame retardant compositions may be used in or with such tape constructions by incorporating the flame retardant compositions into the support material and/or one or more of the functional or structural layers. The flame retardant compositions may, for example, be incorporated into an adhesive which is applied to a support material, or it may be applied as, or together with, a non-adhesive layer within the tape constructions independent of an adhesive layer. There is, therefore, great flexibility in the utility of the provided flame retardant compositions within a tape construction.

In at least one embodiment of the disclosure, a multi-layered tape construction includes a flame retardant adhesive applied to a support material having at least two major surfaces. The flame retardant adhesive is provided as a layer applied to one of the major surfaces of support material. The flame retardant adhesive layer can be of any desired and workable thickness, but is generally in the range from about 12 μm to about 80 μm or even possibly more. The support material is, typically, free of halogen-containing compounds. Suitable support materials include, for example: polymer materials such as polyesters (e.g., PET (polyethylene terephthalate)), polyolefins, polyamides and polyimides; natural and synthetic rubber materials; paper materials; metal foils, glass cloths; and other types of materials. The support material can be of any desired and workable thickness, but is generally between about 25 μm and about 125 μm thick.

Tape constructions that include the flame retardant compositions of the present invention can include primer disposed between flame retardant adhesive and support material. A suitable primer is equivalent to 3M's P-93 primer (a solvent-based composition with acrylonitrile-butadiene polymer, fatty acids, and alcohol). Flame retardant tape constructions may also include a low adhesion backing (or “LAB”) material on the major surface of the support material opposite the major surface including the adhesive and, if present, the primer. The low adhesion backing material can help prevent individual pieces of tape from adhering to each other when a roll is manufactured and wound. Suitable LAB materials include those equivalent to 3M's RD-1547 Urethane Polymer Solution.

### EXAMPLES

The following examples and comparatives are offered to aid in the understanding of the present disclosure and are not to be construed as limiting the scope thereof. Unless otherwise indicated, all parts and percentages are by weight. The following test methods and protocols were employed in the evaluation of the illustrative and comparative examples that follow:

### Test Methods

1. UL 510 (section 6) Flame Retardancy Test

A specimen is exposed to an open flame for a period of fifteen seconds. Upon exposure to the flame, any flame on the test specimen (which typically catches fire) must extinguish in less than 60 seconds to pass the test. The test is repeated five times. Any extinguishing time longer than 60 seconds is considered a failure for the specimen.

Results are reported as “Pass” or “Fail.” Further information regarding the test may be found in the description of the UL 510 standard, Eighth Edition, published by Underwriters Laboratory of Northbrook, Ill., USA.

### 2. UL 510 Ratio of Wet to Dry Dielectric Strength

Testing for dry and wet dielectric strength was performed according to the protocol of ASTM D149-97a. In general, according to this test a sample is placed between two electrodes and power is increased until there is a dielectric failure. Testing for “dry” dielectric strength was performed at room temperature and 50% relative humidity. Testing for “wet” dielectric strength was performed upon exposure of the sample for 96 hours at 23° C. and 96% relative humidity. To pass the dry dielectric strength test, the dielectrics must be greater than or equal to 1000 V/mil. To pass the wet dielectric strength test, at least 90% of the dry dielectric strength must be retained (i.e., the wet dielectrics are greater than or equal to 900 V/mil). To pass UL510, the ratio of wet dielectric breakdown/dry dielectric breakdown must be greater than 90%.

### 3. UL-510 Adhesive Strength to Steel at Room Temperature (“ATS”)

The Adhesive Strength to Steel at Room Temperature of a tape is a measure of the force necessary to remove the tape from a prescribed surface when measured in accordance with ASTM D1000-04. In general, according to this test a sample is placed in crosshead type testing machine, with two clamps to hold the sample in the same plane and the clamps separate from each other recording the force to remove the adhesive tape from the piece of steel. The minimum passing value is 0.454 Kg/in.

### 4. Comparative Tracking Index (“CTI”) Rating

The Comparative Tracking Index (or “CTI”) Rating of a material is a measure of the resistance of a material to surface tracking under defined test conditions. The protocol for the test is set forth in ASTM D3638-07. In general, to perform the test the upper surface of a test specimen is supported in an approximately horizontal plane and subjected to an electrical stress via two electrodes. The surface between the electrodes is subjected to a succession of drops of an electrolyte solution until the over-current device operates, until a persistent flame occurs or until the testing period has elapsed. Individual tests are of short duration (less than 1 hour) with up to 50 or 100 drops of about 20 mg of electrolyte solution falling at 30 second intervals between platinum electrodes spaced 40 mm apart on the test specimen surface. An alternating current voltage between 100 Volts and 600 Volts is applied to the electrodes during the test.

Results are plotted to record the number of drops of electrolyte solution placed on the surface of the specimen versus the recorded voltage. The Comparative Track Index, or CTI, represents the voltage corresponding to 50 drops of electrolyte solution. The lower the CTI rating for a given material, the greater is the creepage distance associated with that material. A CTI Rating is given as follows:

CTI Rating I: CTI≧600 V

CTI Rating II: 400 V≦CTI<600 V

CTI Rating Ma: 175 V≦CTI<400 V

CTI Rating IIIb: 100 V≦CTI<175 V

### Materials Used

| Ingredient | Product Name | Source |
|---|---|---|
| Acrylic Adhesive | 3M Product Number | 3M Company, |
| Polymer (acrylate | 21-3314-0004-0 | St Paul, MM |
| and acrylic acid | (not commercially | |
| copolymer) | available) | |
| Melamine Cyanurate | MELAPUR MC 15 | Ciba |
| | | (now part of BASF), |
| | | Germany |
| Melamine Cyanurate | CG-610 | Chemguard, Taiwan |
| Melamine | MPP-B | Kuo Fong Enterprise, |
| Pyrophosphate | | Taiwan |
| Melamine | MELAPUR 200 | Ciba(now part of BASF), |
| Polyphosphate | | Germany |
| Melamine | BUDIT 3141 | Budenheim, Spain |
| Polyphosphate | | |
| Ammonium | FR CROS S 10 | Budenheim, Spain |
| polyphosphate | | |
| Pyrophosphoric | ZURAN 484 | Chitec, Taiwan |
| acid salts | | |
| Rosin Ester | SYLVALITE RE80HP | Arizona Chemical, |
| Tackifier | | Jacksonville, FL |
| Binder (silicone | LORIAS ASE-50 | Long River Chemical, |
| modified acrylic | | Taiwan |
| copolymer) | | |
| TiO2 | Titanium Dioxide | Dupont, Taipei, |
| | | Taiwan |
| Urethane Solution | RD-1547 | 3M Company, St Paul, |
| Polymer | (not commercially | MN |
| | available) | |
| Primer (solvent- | P-93 | 3M Company, St Paul, |
| based composition | (not commercially | MN |
| with acrylonitrile- | available) | |
| butadiene polymer, | | |
| fatty acids, and | | |
| alcohol) | | |
| PET Film | TAIRILIN BP25 | NanYa, Taoyuan, |
| | | Taiwan |

### Comparative Examples C-1 to C-7 and Examples 1-8

To prepare tape samples for each example and comparative example, an adhesive composition was prepared containing the ingredients, and amounts thereof, identified in Tables 1 and 2, below, based on 100 parts of acrylic adhesive polymer, 3M Company product number 21-3314-0004-0. For each sample, the ingredients for the adhesive composition were mixed using a laboratory-size high intensity mixer in the presence of a solvent (heptane, ethyl acetate or a blend of both). The resulting composition was coated directly onto a 26 um thick TAIRILIN BP25 PET film, primed with 3M P-93 Primer, using either a laboratory knife-coater to produce a handspread samples, or a pilot-size coater (equipped with a knife-coater), to produce a continuous coated film with a nominal coating thickness of about 25 um. After coating, the samples were either placed in a forced-convection oven (in the case of handspread samples) or continuously passed through a tunnel oven (in the case of the continuous film) to extract the solvent and dry the sample. The coated and dried samples were then cut or slit to produce 0.75 inch (1.9 cm) samples. The samples were subjected to the test methodologies described above and the results are indicated in Table 2 and Table 3, below.

TABLE 1
Comparative Examples C-1 to C-7

| | | Binder: | FR agent: | | MC FR | MC FR | MP FR | | | UL 510 | | |
|---|---|---|---|---|---|---|---|---|---|---|---|---|
| | Tackifier: | LORIAS | FR | FR agent: | agent: | agent: | agent: | | UL 510 | wet/dry | UL 510 | |
| | RE80HP | ASE-50 | CROSS 10 | ZURAN | MELAPUR | CG-610 | MPP-B | | FR | diel. strength | ATS | CTI |
| Ex. | (phr) | (phr) | (phr) | 484 | 200 (phr) | (phr) | (phr) | TiO2 | (60 sec) | .>90% | (kg/in) | rating |
| C-1 | 4.4 | 0 | 43.4 | 0 | 0 | 0 | 0 | 0 | Pass | Failed | .208 | 302VIIIa |
| C-2 | 4.5 | 0 | 0 | 43.2 | 0 | 0 | 0 | 0 | Pass | Failed | .333 | 351VIIIa |
| C-3 | 0 | 0 | 0 | 0 | 0 | 80 | 0 | 0 | Fail | Not | .548 | Not |
| | | | | | | | | | | Measured | | Measured |
| C-4 | 0 | 0.3 | 0 | 0 | 0 | 0 | 60 | 12 | Pass | Pass | 1.076 | 300VIIIa |
| C-5 | 0 | 0.3 | 0 | 0 | 60 | 0 | 0 | 12 | Pass | Pass | .660 | 275VIIIa |
| C-6 | 0 | 0 | 0 | 0 | 0 | 10 | 57 | 8 | Pass | Pass | .943 | 300VIIIa |
| C-7 | 0 | 0 | 0 | 0 | 0 | 10 | 57 | 0 | Pass | Pass | .988 | 275VIIIa |

TABLE 2
Examples 1-8

| | Binder: | MC FR | MC FR | MP FR | MP FR | | | UL 510 | | |
|---|---|---|---|---|---|---|---|---|---|---|
| | LORIAS | agent: | agent: | agent: | agent: | | | wet/dry | UL 510 | |
| | ASE-50 | CG-610 | MELAPUR | MPP-B | BUDIT | | UL 510 FR | diel. strength | ATS | CTI |
| Ex. | (phr) | (phr) | MC 15 (phr) | (phr) | 3141 (phr) | TiO2 | (60 sec) | >90% | (kg/in) | rating |
| 1 | 1.4 | 20 | 0 | 40 | 0 | 8 | Pass | Pass | .940 | 600VI |
| 2 | 1.2 | 0 | 33 | 33 | 0 | 0 | Pass | Pass | .944 | 650VI |
| 3 | 0.3 | 29.3 | 0 | 29.3 | 0 | 0 | Pass | Pass | .940 | 650VI |
| 4 | 0.3 | 30.5 | 0 | 30.5 | 0 | 0 | Pass | Pass | 1.075 | 675VI |
| 5 | 0.5 | 45 | 0 | 0 | 22 | 0 | Pass | Pass | .860 | 650VI |
| 6 | 0.5 | 45 | 0 | 0 | 22 | 8 | Pass | Pass | .875 | 625VI |
| 7 | 0 | 57 | 0 | 10 | 0 | 8 | Pass | Pass | .988 | 625VI |
| 8 | 0 | 57 | 0 | 10 | 0 | 0 | Pass | Pass | .976 | 625V1 |

Although the aforementioned detailed description contains many specific details for purposes of illustration, one of ordinary skill in the art will appreciate that many variations, changes, substitutions, and alterations to the details are within the scope of the disclosure as claimed. Accordingly, the disclosure described in the detailed description is set forth without imposing any limitations on the claimed disclosure. The proper scope of the disclosure should be determined by the following claims and their appropriate legal equivalents. All of the references cited are herein incorporated by reference in their entirety.

1. A flame retardant adhesive comprising:
at least one adhesive; and
a flame retardant composition,
wherein the flame retardant composition comprises both a melamine phosphate and a melamine cyanurate.

2. A flame retardant adhesive according to claim 1, wherein the melamine phosphate is a melamine polyphosphate.

3. A flame retardant adhesive according to claim 1, wherein the melamine phosphate is a melamine pyrophosphate.

4. A flame retardant adhesive according to claim 1, wherein the weight ratio of melamine phosphate to melamine cyanurate in the flame retardant composition is about 1:6 to about 2:1.

5. A flame retardant adhesive according to claim 1, wherein the flame retardant composition comprises from about 30 wt % to about 60 wt % of the flame retardant adhesive.

6. A flame retardant adhesive according to claim 1, wherein the flame retardant composition comprises from about 35 wt % to about 50 wt % of the flame retardant adhesive.

7. A flame retardant adhesive according to claim 1, wherein the flame retardant composition comprises from about 38 wt % to about 40 wt % of the flame retardant adhesive.

8. A flame retardant adhesive according to claim 1, wherein the adhesive is a pressure-sensitive adhesive.

9. A flame retardant adhesive according to claim 1, wherein the tape has a CTI rating of I.

10. A flame retardant adhesive according to claim 1, wherein the tape is classified as flame retardant after being tested according to Section 6 of Underwriters Laboratories UL 510, Seventh or Eighth Edition.

11. A tape comprising a support layer having two opposed, major surfaces, and the adhesive of claim 1 disposed on at least one of the major surfaces of the support layer.

12. A tape according to claim 11, wherein the tape has a CTI rating of I.

13. A tape according to claim 11, wherein the tape is classified as flame retardant after being tested according to Section 6 of Underwriters Laboratories UL 510, Seventh or Eighth Edition.

14. A tape comprising a support layer having two opposed, major surfaces, an adhesive disposed on at least one of the major surfaces of the support layer, and a flame retardant composition comprising a melamine phosphate and a melamine cyanurate, the flame retardant composition being disposed in the support layer, on the support layer, or a combination thereof.

15. A tape according to claim 14, wherein the melamine phosphate comprises a melamine polyphosphate.

16. A tape according to claim 14, wherein the melamine phosphate comprises a melamine pyrophosphate.

17. A tape according to claim 14, wherein the weight ration of melamine phosphate to melamine cyanurate in the flame retardant composition is about 1:6 to about 2:1.

18. A tape according to claim 15, wherein the tape has a CTI rating of I.

19. A tape according to claim 15, wherein the support layer comprises a polyester, a polyolefin, a polyamide, or a polyimide.

20. A tape according to claim 15, wherein the tape is classified as flame retardant after being tested according to Section 6 of Underwriters Laboratories UL 510, Seventh or Eighth Edition.
